(19) United States
(12) Patent Application Publication
(10) Pub. No.: US 2016/0369810 A1
(43) Pub. Date: Dec. 22, 2016

(54) FUEL PUMP

(71) Applicant: DENSO CORPORATION, Kariya-city (JP)

(72) Inventors: Hiromi SAKAI, Kariya-city (JP); Yuuji HIDAKA, Kariya-city (JP); Masaya OOTAKE, Kariya-city (JP)

(21) Appl. No.: 15/184,136

(22) Filed: Jun. 16, 2016

(30) Foreign Application Priority Data
Jun. 17, 2015 (JP) 2015-121701

(51) Int. Cl. F04D 29/06; F04D 3/00; F02M 37/08; F04D 29/18; F04D 29/52; F04D 13/06; F04D 29/043

(52) U.S. Cl. CPC F04D 29/061; F04D 13/06; F04D 3/005; F04D 29/043; F04D 29/181; F04D 29/528; F02M 37/08

(57) ABSTRACT

A fuel pump includes a shaft integrally rotatable with a rotor, and an impeller including a fitting hole to which the shaft is fitted. The shaft includes shaft contact surfaces which contact flat surfaces that form the fitting hole when the shaft rotates. The shaft contact surfaces include grooves formed to extend in a center axis direction of the shaft.

### CROSS REFERENCE TO RELATED APPLICATION

The present application is based on Japanese Patent Application No. 2015-121701 filed on Jun. 17, 2015, disclosure of which is incorporated herein by reference.

### TECHNICAL FIELD

The present disclosure relates to a fuel pump.

### BACKGROUND

It is known that a type of fuel pump includes a pump unit and a motor unit. The pump unit includes a pump chamber that rotatably houses an impeller. The motor unit includes a shaft coupled to the impeller, and generates a driving force able to rotate the impeller. As the impeller rotates, the fuel pump pumps fuel from a fuel tank to an internal combustion engine. For example, JP 2001-25221 A describes a fuel pump that includes a shaft having an end portion formed with a substantially rectangular cross section, an impeller having a fitting hole that fits with this end portion, and the like.

### SUMMARY

The impeller included in the fuel pump pressurizes fuel flowing into the pump chamber from a center axis direction of the impeller, and discharges this pressurized fuel in the center axis direction toward an opposite side from the side of the unpressurized fuel flowing into the pump camber. If the fuel flowing into the pump chamber includes easily vaporized components such as alcohol components, air bubbles may for in the fuel based on the environmental conditions during operation of the fuel pump. In the fuel pump, a clearance is formed between the impeller and the inner wall of the pump chamber such that the impeller is able to rotate. Accordingly, depending on the amount and the position of the air bubbles, the impeller may repeatedly oscillate in the center axis direction of the impeller. In this case, since friction is repeatedly generated between the impeller and the shaft fitted to the fitting hole, there is a concern that the impeller may be damaged.

It is an object of the present disclosure to provide a fuel pump that prevents an impeller from damage.

According to the present disclosure, a fuel pump includes a pump case including an inlet port and a discharge port, a stator, a rotor rotatably disposed radially inward of the stator, a shaft disposed coaxially with the rotor, the shaft being integrally rotatable with the rotor, and an impeller including a fitting hole, an end portion of the shaft being fitted into the fitting hole.

In the fuel pump of the present disclosure, the impeller is configured to pressurize the fuel sucked in from the inlet port and discharge the fuel from the discharge port when the shaft rotates, the end portion of the shaft includes a contact surface that abuts an inner wall of the impeller when the shaft rotates, the inner wall of the impeller forming the fitting hole, and the contact surface includes a groove formed to extend in a center axis direction of the shaft.

According to the fuel pump of the present disclosure, the contact surface of the shaft includes the groove formed to extend in the center axis direction of the shaft. Here, “groove formed to extend in the center axis direction of the shaft” indicates a groove formed to open in the center axis direction of the shaft, which may be formed with any angle other than 90 degrees with respect to the center axis of the shaft, and is not limited to a groove formed parallel with the center axis of the shaft. Liquids, such as oil or fuel in the fuel pump, flows into the groove formed to extend in the center axis direction of the shaft to reduce friction between the shaft and the impeller. Accordingly, a liquid tends to exist between the contact surface of the shaft and the inner wall of the impeller. As a result, even if the impeller vibrates in the center axis direction due to air bubbles forming in the fuel and the impeller repeatedly slides against the shaft, the friction of the impeller may be reduced. Accordingly, the impeller may be protected from damage.

### BRIEF DESCRIPTION OF THE DRAWINGS

The disclosure, together with additional objectives, features and advantages thereof, will be best understood from the following description, the appended claims and the accompanying drawings, in which:

FIG. 1 is a cross section view of a fuel pump according to a first embodiment;

FIG. 2 is a schematic view of an impeller included in the fuel pump of the first embodiment;

FIGS. 3A and 3B are schematic views explaining a machining process of a shaft included in the fuel pump of the first embodiment;

FIG. 4 is an enlarged cross section view of a contact surface of the shaft included in the fuel pump of the first embodiment;

FIG. 5 is a schematic view explaining the operation of the fuel pump of the first embodiment;

FIG. 6 is a partial cross section view of a fuel pump according to a second embodiment; and

FIGS. 7A and 7B are schematic views explaining a machining process of a shaft included in a fuel pump of a comparative example.

### DETAILED DESCRIPTION

A plurality of embodiments of the present disclosure will be explained with reference to the figures.

### First Embodiment

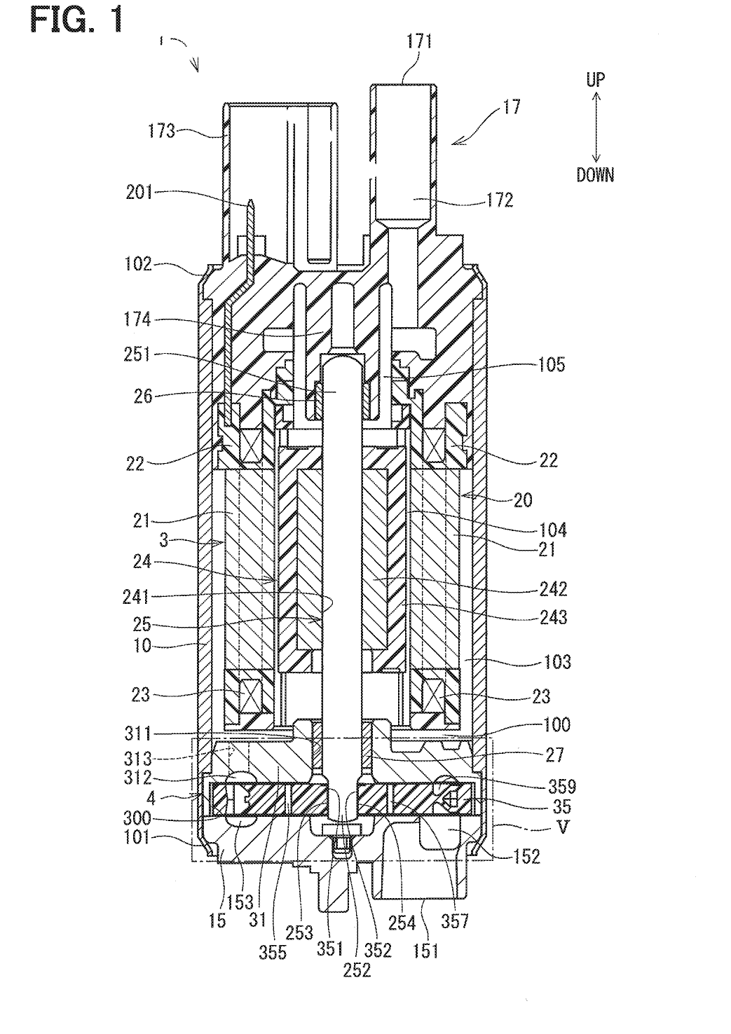

A fuel pump according to a first embodiment of the present disclosure will be explained with reference to FIGS. 1 to 5.

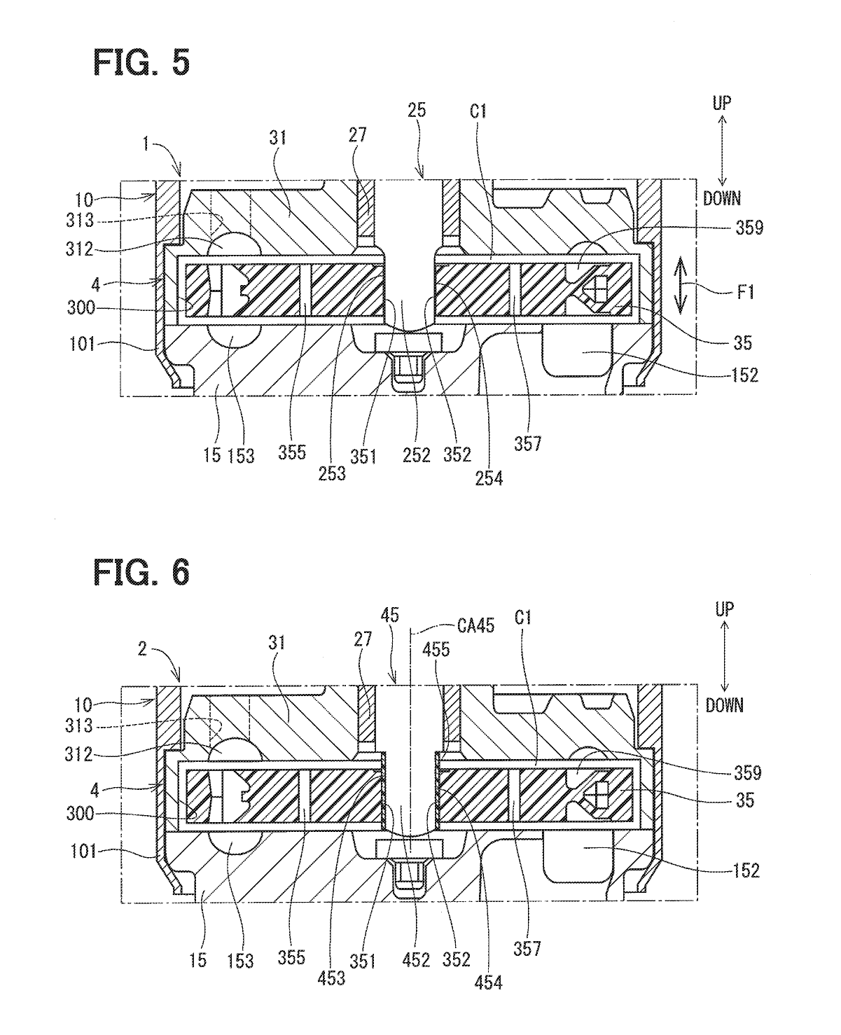

A fuel pump 1 includes a housing 10, a motor unit 3, a pump unit 4, a pump cover 15, and a cover end 17. In the fuel pump 1, the motor unit 3 and the pump unit 4 are housed within a space defined by the housing 10, the pump cover 15, and the cover end 17. The fuel pump 1 takes in fuel from a fuel tank (not illustrated) through an intake port 151, and discharges this fuel through a discharge port 171 to an internal combustion engine. In addition, in FIGS. 1 and 5, the upward direction is referred to as “up” or “top”, while the downward direction is referred to as “down” or “bottom”. The housing 10, the pump cover 15, and the cover end 17 correspond to a “pump case”.

The housing 10 is formed in a cylindrical shape from a metal such as iron. The pump cover 15 and the cover end 17 are disposed at a bottom end portion 101 and a top end portion 102 of the housing 10, respectively.

The pump cover 15 is disposed so as to cover the bottom end portion 101 of the housing 10. The edge of the bottom end portion 101 is crimped inward to fix the pump cover 15 to the inner side of the housing 10. The pump cover 15 includes the intake port 151 which opens toward the bottom side. The intake port 151 is in communication with an intake passage 152 which penetrates up and down through the pump cover 15. In addition, a groove 153, which is in communication with the intake passage 152, is formed on the top side of the pump cover 15.

The cover end 17 is formed of resin, and is disposed so as to cover the top end portion 102 of the housing 10. The edge of the top end portion 102 is crimped to fix the cover end 17 to the inner side of the housing 10. The cover end 17 includes the discharge port 171 which opens upward. The discharge port 171 is in communication with a discharge passage 172 that penetrates up and down through the cover end 17. In addition, an electrical connector portion 173 is disposed in a different part of the cover end 17 than the part forming the discharge port 171. The electrical connector portion 173 houses a connection terminal 201 which receives electric power from an external source. A substantially cylindrical bearing housing portion 174 is disposed on the bottom side of the cover end 17. A bearing 26 is inserted into the bearing housing portion 174. The bearing 26 rotatably supports an upper end portion 251 of a shaft 25.

When electric power is supplied to the motor unit 3, a magnetic field is generated. The motor unit 3 uses this magnetic field to generate a rotation torque. The motor unit 3 includes a stator 20, a rotor 24, and the shaft 25. In addition, the motor unit 3 of the fuel pump 1 according to the first embodiment is a brushless motor that is able to detect the position of the rotor 24 with respect to the stator 20 due to the rotation of the shaft 25.

The stator 20 is cylindrical shaped, and is housed within the housing 10. The stator 20 includes six cores 21, six bobbins 22, six windings 23, and three connection terminals 201. The stator 20 is formed by integrally molding these components with resin.

The core 21 is formed by stacking a plurality of magnetic members, each of which may be, for example, an iron sheet. The core 21 is arranged in the circumferential direction and positioned to face a magnet 243 of the rotor 24.

The bobbins 22 are formed of a resin material, and the core 21 is inserted during molding. Accordingly, the bobbins 22 are integrally provided with the core 21.

The windings 23 may be, for example, copper wiring coated with an insulating film. One of the windings 23 forms a coil by winding around one of the bobbins 22 with the core 21 inserted. The windings 23 are electrically connected to the connection terminal 201 housed in the electrical connector portion 173.

The connection terminal 201 penetrates through the cover end 17 and is fixed to the top of the bobbins 22. According to the fuel pump 1 of the first embodiment, three connection terminals 201 are provided, and receive three-phase electric power from a power source device (not illustrated).

The rotor 24 is rotatably disposed inside of the stator 20. The rotor 24 includes a magnet 243 disposed around an iron core 242. The magnet 243 is arranged with alternating N poles and S poles.

The shaft 25 is formed with a substantially circular cross section perpendicular to the center axis, except for a lower end portion 252 which corresponds to “an end portion”. The shaft 25 is fixedly press fit into a shaft hole 241 formed in the center axis of the rotor 24. Accordingly, the shaft 25 and the rotor 24 integrally rotate.

The lower end portion 252 of the shaft 25 is formed with a substantially rectangular cross section perpendicular to the center axis. The lower end portion 252 is connected to the pump unit 4. The lower end portion 252 includes shaft contact surfaces 253, 254 which are formed as flat surfaces extending toward the top.

The pump unit 4 uses the rotation torque generated by the motor unit 3 to pressurize fuel sucked in from the intake port 151, and discharges this fuel into the housing 10. The pump unit 4 includes a pump casing 31 and an impeller 35.

The pump casing is substantially discoid shaped, and is disposed between the pump cover 15 and the stator 20. A throughhole 311 is formed in the center portion of the pump casing 31 and penetrates through the pump casing 31 in the thickness direction. A bearing 27 is fitted inside the throughhole 311. The bearing 27 rotatably supports the lower end portion 252 of the shaft 25. Accordingly, the rotor 24 and the shaft 25 are rotatable with respect to the cover end 17 and the pump casing 31.

In addition, a groove 312 is formed on the bottom side of the pump casing 31, and is positioned to face the groove 153 of the pump cover 15. The groove 312 is in communication with a fuel passage 313 which penetrates up and down through the pump casing 31.

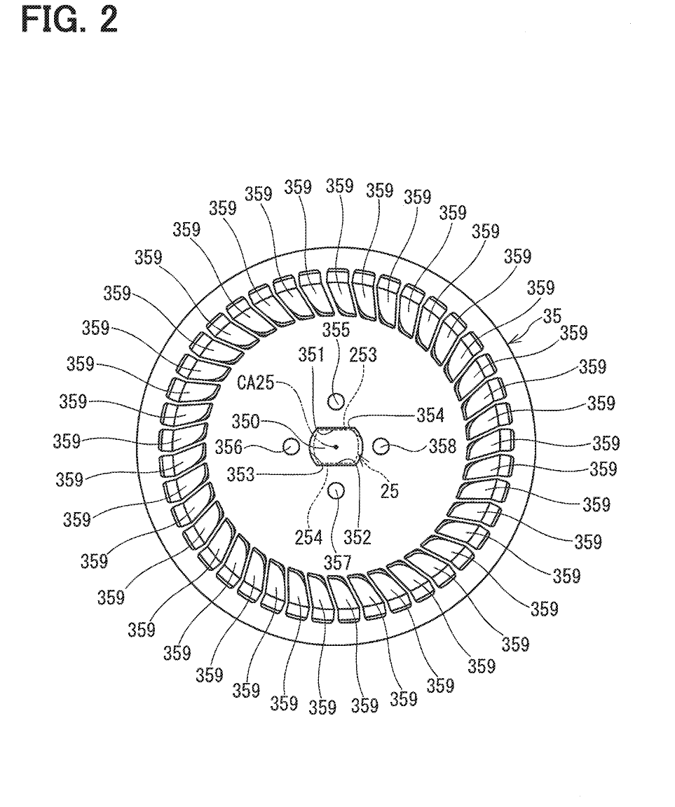

The impeller 35 is substantially discoid shaped, and is formed by resin. The impeller 35 is housed within a pump chamber 300 between the pump cover 15 and the pump casing 31. A fitting hole 350 is formed in substantially the center of the impeller 35 (see FIG. 2), and the lower end portion 252 of the shaft 25 is fitted into the fitting hole 350. The fitting hole 350 is formed by two flat surfaces 351, 352 and two curve surfaces 353, 354, which correspond to an “impeller inner wall”. The two curved surfaces 353, 354 are connected to either end of the two flat surfaces 351, 352. In addition, the two flat surfaces 351, 352 are abuttable with the shaft contact surfaces 253, 254. The shaft contact surfaces 253, 254 correspond to a “contact surface”.

Holes 355, 356, 357, 358 are formed in the impeller 35 around the fitting hole 350, and penetrate up and down through the impeller 35. The holes 355, 356, 357, 358 connect the top and bottom sides of the impeller 35 in the pump chamber 300, and allow fuel to flow such that the fuel pressure in the pump chamber 300 is not biased.

The impeller 35 includes a plurality of vane grooves 359 located radially outward of the fitting hole 350. The vane grooves 359 are disposed at locations corresponding to the groove 153 and the groove 312. The vane grooves 359 are, as shown in FIG. 2, disposed at the radially outward edge portion of the impeller 35 with equal spacing in the circumferential direction.

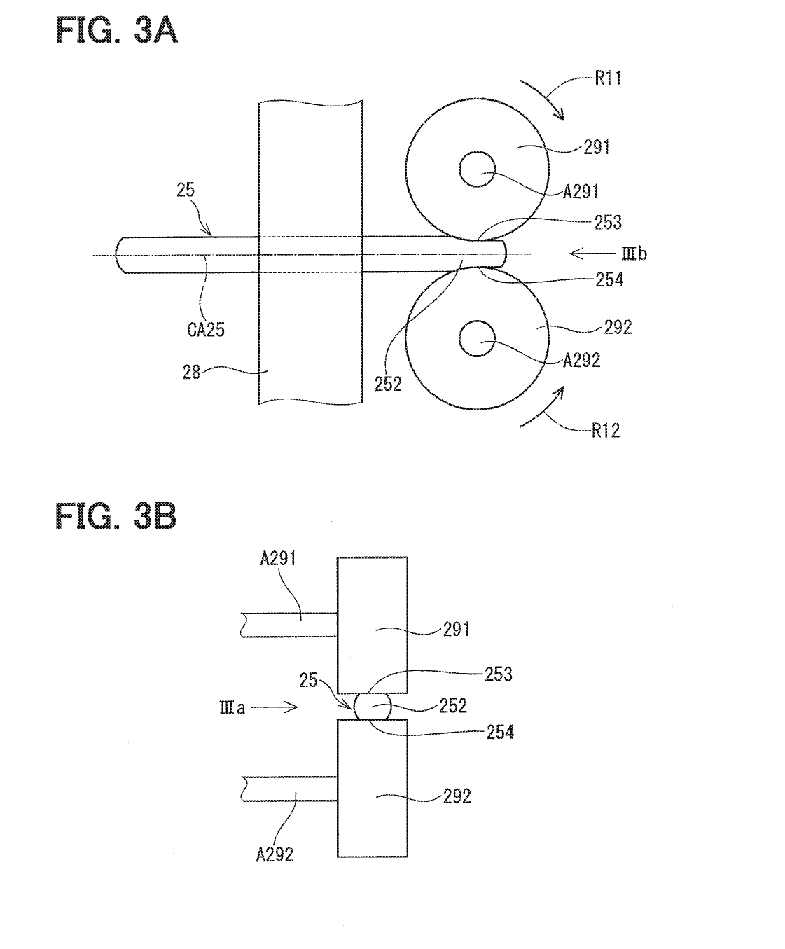

Next, the machining process of the shaft contact surfaces 253, 254 of the fuel pump 1 will be explained with reference to FIG. 3.

When machining the two shaft contact surfaces 253, 254 which are disposed substantially parallel to the lower end portion 252 of the shaft 25, first, a support tool 28 is used to support substantially the center of the shaft 25 before the shaft contact surfaces 253, 254 are machined.

Next, rotational-type grindstones 291, 292 are applied to the lower end portion 252 to grind out the shaft contact surfaces 253, 254. At this time, as shown in FIG. 3A, the rotational axes A291, A292 of the grindstones 21, 292 are disposed substantially perpendicular to the center axis CA25 of the shaft 25, and the grindstones 291, 292 rotate in the directions indicated by the solid arrows R11, R12 of FIG. 3A.

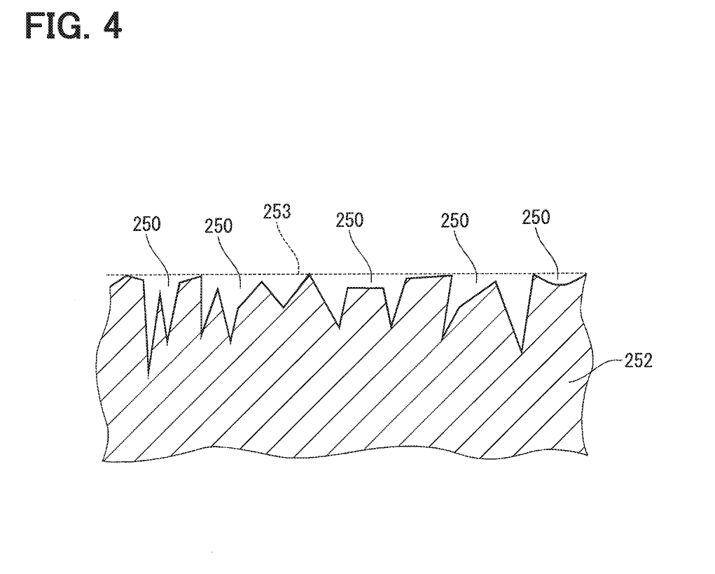

FIG. 4 shows an enlarged view of a cross section of the shaft contact surface 253 perpendicular to the center axes CA25. When the shaft contact surface 253 is machined by grinding, the grindstone 291 rotates so as to move in the center axis CA25 direction with respect to the lower end portion 252. Accordingly, as shown in FIG. 4, after being grinded the shaft contact surface 253 includes a plurality of grooves 250 along the center axis CA25 direction formed so as to extend in the center axis CA25 direction. Many of the grooves 250 have openings which allow liquids in the fuel pump, such as oil or fuel, to flow into the top side or the bottom side of the shaft contact surfaces 253, 254. In addition, the grooves 250 have sufficient depth to retain the liquids in the fuel pump 1. Preferably, the shaft contact surface 253 has a center line average roughness Ra of 0.8 or above. The above explanation is provided for the shaft contact surface 253, but the same applies to the shaft contact surface 254.

Next, the operation of the fuel pump 1 will be explained with reference to FIGS. 1 and 5. In addition, for easy of understanding, the clearance between the impeller 35 and the wall surfaces of the pump cover 15 and the pump casing 31 which form the pump chamber 300 is illustrated as bigger than normal in FIG. 5.

According to the fuel pump 1, when the windings of the motor unit 3 are supplied with electric power through the connection terminal 201, the rotor 24 and the shaft 25, along with the impeller 35, rotate. When the impeller 35 rotates, the fuel pump 1 sucks in fuel from a fuel tank through the intake port 151 into the grooves 153, 312 of the pump chamber 300. Due to the rotation of the impeller 35, the sucked in fuel flows in a spiral swirl flow between the vane grooves 359 and the grooves 153, 312, and is pressurized. The pressurized fuel is guided through the fuel passage 313 and into an intermediate chamber 100 formed between the pump casing 31 and the motor unit 3.

The fuel guided into the intermediate chamber 100 is guided through a fuel passage 103 and a fuel passage 104 into a fuel passage 105. The fuel passage 103 is formed between the inner wall of the housing 10 and the outer wall of the stator 20. The fuel passage 104 is formed between the rotor 24 and the stator 20. The fuel passage 105 is formed radially outward of the bearing housing portion 174. The fuel guided into the fuel passage 105 is discharged through the discharge passage 172 and the discharge port 171.

In the fuel pump 1, when alcohol components are included in the fuel sucked in from the intake port 151 into the pump chamber 300, air bubbles may be generated in the sucked in fuel according to the operating environmental conditions of the fuel pump 1. As shown in FIG. 5, according to the fuel pump 1, a fixed amount of clearance is disposed between the impeller 35 and the inner walls of the pump chamber 300. For this reason, when fuel including air bubbles is sucked into the pump chamber 300, the impeller 35 vibrates up and down as shown by the double ended arrow Fl in FIG. 5 according to the amount of air bubbles and the positions of the air bubbles with respect to the impeller 35. As the impeller 35 vibrates up and down, the shaft contact surfaces 253, 254 of the shaft 25 repeatedly slide against the flat surfaces 351, 352 which form the fitting hole 350.

According to the fuel pump 1, the shaft 25 include the plurality of grooves 250 in the shaft contact surfaces 253, 254, and the grooves 250 extend in the center axis CA25 direction. The grooves 250 have a depth sufficient to retain the liquids in the fuel pump 1, such as oil or fuel. As such, a membrane of the liquids in the fuel pump 1 tends to form between the shaft contact surfaces 253, 254 and the flat surfaces 351, 352 of the impeller 35.

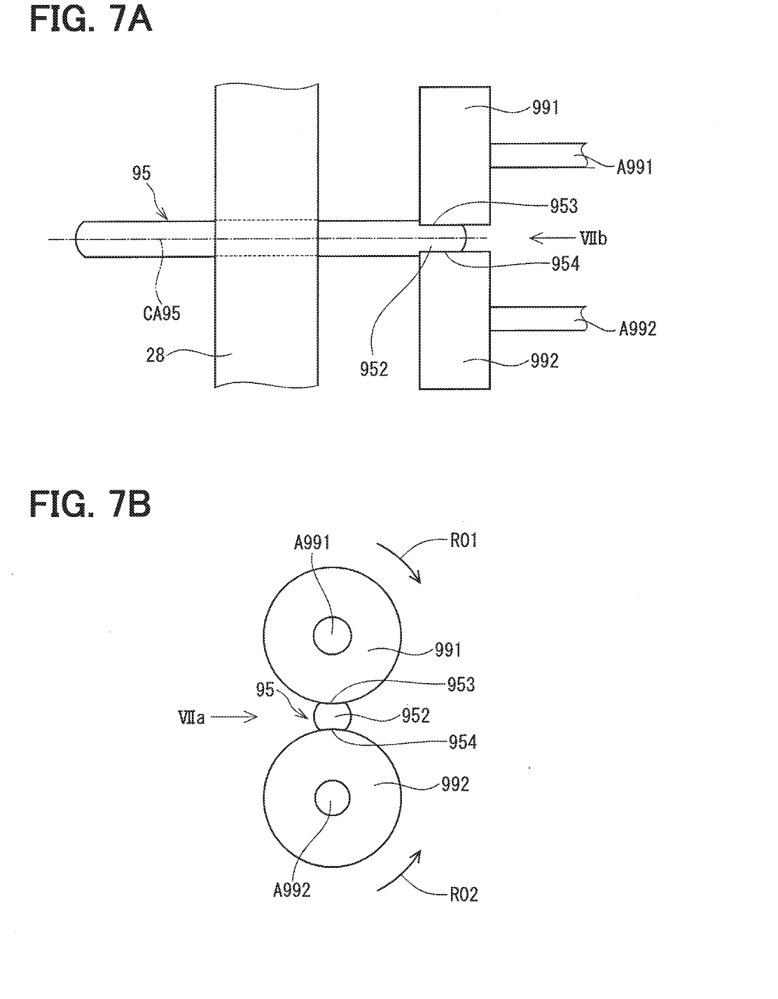

In this case, as a comparative example, the machining process of a shaft 95, different from the shaft 25, will be explained with reference to FIG. 7.

According to the shaft 95, when machining shaft contact surfaces 953, 954 which are contactable with an inner wall of an impeller that forms a fitting hole, grindstones 991, 992 are applied to an end portion 952 of the shaft 95 which is fitted into the fitting hole. Here, the rotation axes A991, A992 of the grindstones 991, 992 are disposed substantially parallel to the center axis CA95 of the shaft 95. Accordingly, the grindstones 991, 992 rotate in the directions shown by the solid arrows R01, R02 in FIG. 7B, thereby forming grooves in the shaft contact surfaces 953, 954 which extend in a direction substantially perpendicular to the center axis CA 95. In this case, it is difficult to maintain a liquid membrane which reduces friction between the entire surface of the shaft contact surfaces 953, 954 and the inner wall of the impeller. Accordingly, there is a concern that the impeller may be damaged due to the impeller vibrating the in center axis CA95 direction with respect to the shaft 95.

In contrast, according to the fuel pump 1, a liquid membrane is formed between the shaft contact surfaces 253, 254 and the flat surfaces 351, 352 of the impeller 35 due to the shaft contact surfaces 253, 254 having the grooves 250. Accordingly, friction between the shaft 25 and the impeller 35 may be reduced. As a result, it is possible to protect the impeller 35 from being damaged due to friction, even if the impeller 35 vibrates up and down with respect to the shaft 25,

### Second Embodiment

Next, a second embodiment of the present disclosure will be explained with reference to FIG. 6. The second embodiment is different from the first embodiment in that the shaft includes a coating. In addition, portions which are substantially the same as those of the first embodiment are denoted with the same reference numeral, and explanations thereof are omitted for brevity.

FIG. 6 shows a partial cross sectional view of a fuel pump 2 according to the second embodiment. The fuel pump 2 includes a housing 10, a motor unit 5, a pump unit 4, a pump cover 15, and a cover end 17. The motor unit 5 includes a stator 20, a rotor 24, and a shaft 45. In addition, in FIG. 6, the upward direction is referred to as “up” or “top”, while the downward direction is referred to as “down” or “bottom”.

The shaft 45 includes shaft contact surfaces 453, 454 in a lower end portion 452. The shaft contact surfaces 453, 454 are shaped as flat surfaces that extend up and down. The shaft contact surfaces 453, 454 are configured to be abuttable with two flat surfaces 351, 352 which are inner walls of a fitting hole 350 of the impeller 35. The shaft contact surfaces 453, 454 include grooves that extend in the direction of the center axis CA45 of the shaft 45.

In addition, the shaft 45 includes a coating 455 on the shaft contact surfaces 453, 454. The coating 455 is able to reduce friction between the shaft 45 and the impeller 35, and may be formed of, for example, fluorine resin.

According to the fuel pump 2 of the second embodiment, the coating 455 reduces friction between the shaft 45 and the impeller 35. Accordingly, as compared to the first embodiment, the second embodiment further reduces friction between the shaft 45 and the impeller 35, and may prevent damage to the impeller 35.

### Other Embodiments

In the above described embodiments, the shaft contact surfaces, after being grinded, have grooves which extend in the center axis direction substantially parallel with the center axis of the shaft. However, the grooves are not limited to extending in this direction, as long as grooves are formed to extend in the center axis direction. When a plurality of grooves are formed on the shaft contact surfaces, it is acceptable if at least one of the grooves includes an opening in the center axis direction of the shaft such that liquids in the fuel pump may flow in, and may be formed with any angle aside from 90 degrees with respect to the center axis of the shaft. In addition, if only one groove is formed in the shaft contact surfaces after grinding, this single groove may be formed with any angle other than 90 degrees with respect to the center axis of the shaft, as long as the groove includes an opening in the center axis direction of the shaft. Due to this, a liquid membrane tends to form between the shaft contact surfaces of the shaft and the flat surfaces forming the fitting hole of the impeller, and therefore friction between the impeller and the shaft may be reduced.

In the above described embodiments, the lower end portion of the shaft fitted in the fitting hole of the impeller includes two shaft contact surfaces. However, there may be only one shaft contact surface instead.

In the second embodiment, the lower end portion of the shaft includes a coating to reduce friction. However, the coating may be disposed on the entire outer wall of the shaft instead. In this case, as compared to only forming a coating on the lower end portion, a masking step during machining of the shaft may be omitted.

In the above described embodiments, the shaft contact surfaces are machined by grinding with grindstones. However, the shaft contact surfaces are not limited to being machined in this manner. For example, the shaft contact surfaces may be machined by a cutter, or machined with other tools.

The present disclosure is not limited to these embodiments, and variety of modifications which do not depart from the gist of the present disclosure are contemplated.

1. A fuel pump, comprising:
a pump case including an inlet port that sucks in fuel and a discharge port that discharges the fuel;
a cylindrical stator including a plurality of windings, the stator being fixed inside the pump case;
a rotor rotatably disposed radially inward of the stator;
a shaft disposed coaxially with the rotor, the shaft being integrally rotatable with the rotor; and
an impeller including a fitting hole, an end portion of the shaft being fitted into the fitting hole, wherein
the impeller is configured to pressurize the fuel sucked in from the inlet port and discharge the fuel from the discharge port when the shaft rotates,
the end portion of the shaft includes a contact surface that abuts an inner wall of the impeller when the shaft rotates, the inner wall of the impeller forming the fitting hole, and
the contact surface includes a groove formed to extend in a center axis direction of the shaft.

2. The fuel pump of claim 1, wherein
the groove has a depth sufficient to retain liquid.

3. The fuel pump of claim 1, wherein
the contact surface has a surface roughness sufficient to form a liquid membrane that reduces friction between the shaft and the impeller.

4. The fuel pump of claim 1, wherein
the shaft includes a coating on the contact surface that reduces friction between the shaft and the impeller.

5. The fuel pump of claim 4, wherein
the coating is formed on an outer wall of the shaft.
